(19) United States
(12) Patent Application Publication
(10) Pub. No.: US 2006/0158498 A1
(43) Pub. Date: Jul. 20, 2006

(54) Color filter fabricating method using an inkjet process

(76) Inventors: Min-soo Kim, Seoul (KR); Seung-joo Shin, Seoul (KR)

Correspondence Address: LEE & MORSE, P.C., 1101 WILSON BOULEVARD, SUITE 2000, ARLINGTON, VA, 22209, US

(21) Appl. No.: 11/333,493

(22) Filed: Jan. 18, 2006

(30) Foreign Application Priority Data
Jan. 19, 2005 (KR) 10-2005-0005026

(51) Int. Cl. G01D 11/00

(52) U.S. Cl. 347/100

(57) ABSTRACT

A method of fabricating a color filter includes depositing an ink color in a pixel of a substrate using at least two printing process cycles, wherein at least one of a size of an ink droplet and a number of ink droplets is varied between the at least two printing process cycles.

### BACKGROUND OF THE INVENTION

1. Field of the Invention

The present invention relates to a color filter fabrication method. More particularly, the present invention relates to a color filter fabrication method using an inkjet process.

2. Description of the Related Art

Cathode ray tube (CRT) monitors have been widely used in televisions (TVs) and computers for displaying information. Recently, as display screens have increased in size, flat panel display devices have become popular substitutes for CRTs. Examples of flat panel display devices include liquid crystal displays (LCDs), plasma display panels (PDPs), electroluminescence (EL) displays, light emitting diode (LED) displays, and field emission displays (FEDs). The LCD has been widely used for computer monitors and notebook PCs because of its low power consumption.

The typical LCD includes a color filter, and creates an image of a desired color by transmitting white light that is modulated by a liquid crystal layer. The color filter may include a plurality of red (R), green (G) and blue (B) pixels that are arranged in a predetermined pattern on a transparent substrate. Examples of methods of fabricating the color filter include dyeing methods, pigment dispersion methods, printing methods, and electrodeposition methods. These methods may involve fabrication processes that are inefficient and expensive, because they may require that a given process be repeated to form each of the R, G and B pixels.

A color filter fabrication method that avoids these inefficiencies involves using an inkjet process, which may simplify the overall fabrication process and reduce the fabrication cost. In the color filter fabrication method using the inkjet process, ink droplets of a given color (e.g., R, G or B color) are discharged through nozzles of an inkjet head onto each pixel on a substrate to form a pixel of the given color. Each pixel may be formed by repeating, for a predetermined number of cycles, a printing step of discharging ink droplets. However, when ink droplets of the same size are used throughout the repeated printing steps, ink overflow may occur in the latter printing steps. In addition, the amount of pigment may be difficult to precisely adjust and, thus, a pixel of a desired color may be difficult to obtain.

### SUMMARY OF THE INVENTION

The present invention is therefore directed to a color filter fabricating method using an inkjet process, which substantially overcomes one or more of the problems due to the limitations and disadvantages of the related art.

It is therefore a feature of an embodiment of the present invention to provide a color filter fabricating method that includes depositing an ink color in a pixel of a substrate using at least two printing process cycles.

It is therefore another feature of an embodiment of the present invention to provide a color filter fabricating method using an inkjet process wherein a size of an ink droplet, a number of ink droplets, or both, may be varied while forming a pixel of the color filter.

It is therefore yet a further feature of an embodiment of the present invention to provide a color fabrication method including a flaw repairing process.

At least one of the above and other features and advantages of the present invention may be realized by providing a method of fabricating a color filter including depositing an ink color in a pixel of a substrate using at least two printing process cycles, wherein at least one of a size of an ink droplet and a number of ink droplets is varied between the at least two printing process cycles.

The size of an ink droplet deposited in the pixel may be varied between the at least two printing process cycles. The size of an ink droplet deposited in the pixel may decrease between the at least two printing process cycles. The size of an ink droplet deposited in the pixel may linearly decrease between the at least two printing process cycles. The number of ink droplets deposited in the pixel may be held constant between the at least two printing process cycles. The number of ink droplets deposited in the pixel may be varied between the at least two printing process cycles. The size and the number of ink droplets deposited in the pixel may decrease between the at least two printing process cycles. The printing process may be a piezoelectric printing process and a waveform of a signal applied to a piezoelectric element may be varied in order to vary the size of ink droplets deposited in the pixel.

The number of ink droplets deposited in the pixel may be varied between the at least two printing process cycles. The number of ink droplets deposited in the pixel may decrease between the at least two printing process cycles. The number of ink droplets deposited in the pixel may linearly decrease between the at least two printing process cycles.

The method may further include determining a number of printing process cycles for depositing the ink color in the pixel, setting a size of ink droplets for each of the printing process cycles, setting a number of ink droplets for each of the printing process cycles, performing the number of printing process cycles, and completing a final printing process.

The method may further include performing a flaw repairing process after performing each printing process cycle and before completing the final printing process. The flaw repairing process may include adjusting at least one of the size of an ink droplet and the number of ink droplets, and performing a printing task for the flaw repairing process until a pixel light transmittance requirement is satisfied.

The method may further include performing a flaw repairing process after completing the final printing process. The flaw repairing process may include adjusting at least one of the size of an ink droplet and the number of ink droplets, and performing a printing task for the flaw repairing process until a pixel light transmittance requirement is satisfied.

Depositing an ink color in a pixel of a substrate using at least two printing process cycles may include setting initial values for a first of the at least two printing process cycles, wherein setting the initial values includes setting an initial size of ink droplets, and setting an initial number of ink droplets, performing the first printing process cycle to deposit the ink color in the pixel, determining a pixel light transmittance after performing the first printing process cycle, varying at least one of the size of ink droplets and the number of ink droplets based on the pixel light transmittance, and subsequently performing a second of the at least two printing process cycles to deposit the ink color in the pixel. The pixel may be defined by a black matrix formed on the substrate.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIGS. 1A through 1C illustrate schematic views of stages in a color filter fabrication method according to a first embodiment of the present invention;

FIGS. 2A through 2C illustrate schematic views of stages in a color filter fabrication method according to a second embodiment of the present invention;

FIGS. 3A through 3C illustrate schematic views of stages in a color filter fabrication method according to a third embodiment of the present invention;

FIG. 4 illustrates a flowchart of a color filter fabrication method according to an embodiment of the present invention; and

FIG. 5 illustrates a flowchart of a color filter fabrication method according to another embodiment of the present invention.

### DETAILED DESCRIPTION OF THE INVENTION

Korean Patent Application No. 10-2005-0005026, filed on Jan. 19, 2005, in the Korean Intellectual Property Office, and entitled: “Color Filter Fabricating Method Using Inkjet Process,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A color filter may be fabricated by forming a black matrix of a predetermined pattern on a substrate, e.g., a transparent substrate, and forming pixels of given colors (e.g., R, G and B colors) in respective pixels partitioned by the black matrix.

According to the method of the present invention, each pixel of a color filter may be formed by a printing process. The printing process may involve, e.g., inkjet printing. The printing process may include a plurality of printing process cycles. In the printing process, a pixel of a desired color may be formed by repeating a cycle including a printing step in which ink droplets of a given color (e.g., one of R, G and B colors) are discharged through nozzles of an inkjet head onto each pixel on the substrate. The cycle may be repeated, e.g., for a predetermined number of times, or for a number of times that is determined during the printing process.

Where the printing process involves inkjet printing, a piezoelectric inkjet head or a thermal inkjet head may be used. Generally, the piezoelectric inkjet head discharges ink droplets through its nozzles by pressure that is applied on the ink due to deformation of a piezoelectric element. In contrast, the thermal inkjet head discharges ink droplets through its nozzles by the expansive force of ink bubbles that are formed and expanded by a heat source. Those of skill in the art of inkjet printing will be familiar with the details of these processes.

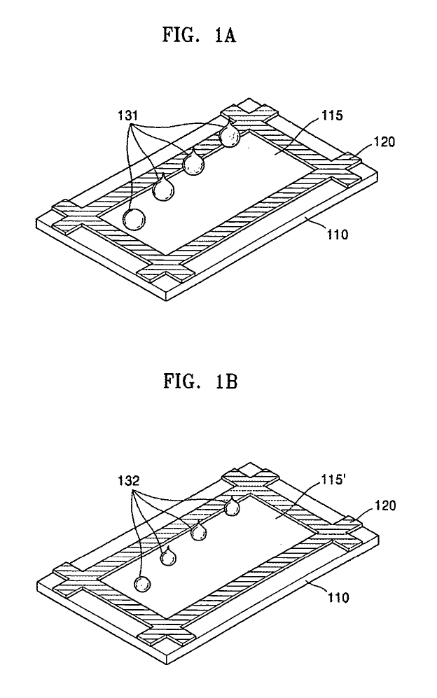

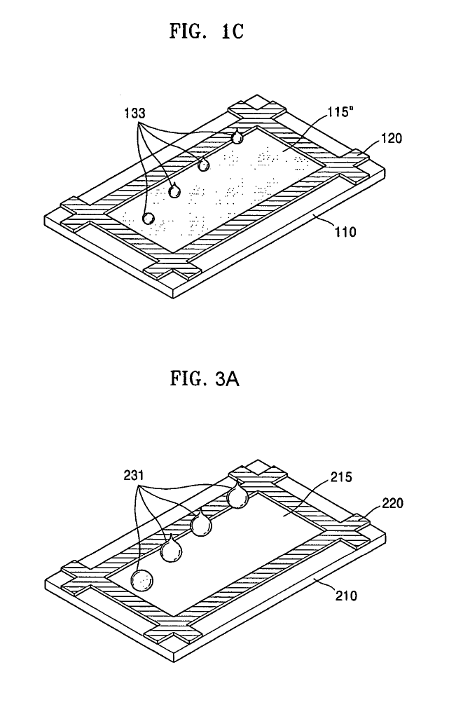

FIGS. 1A through 1C illustrate schematic views of stages in a color filter fabrication method according to a first embodiment of the present invention. For conciseness and clarity of explanation, the method will be explained with respect to a process of forming a single pixel of a single given color on a substrate. However, it will be appreciated that many pixels may be formed in a similar fashion, and that the processes may be repeated with a plurality of colors.

Referring to FIG. 1A, a black matrix 120 of a predetermined pattern may be formed on a substrate 110. Substrate 110 may be, e.g., a transparent substrate. The transparent substrate 110 may be, e.g., a glass substrate or a plastic substrate. The black matrix 120 may be formed by, e.g., coating the substrate 110 with an opaque material to a predetermined thickness and patterning the deposited opaque material in the predetermined pattern. The black matrix 120 may partition respective pixels 115 on the transparent substrate 110, in which pixels of given colors (e.g., R, G and B colors) are formed. After formation of the black matrix 120, a printing process according to the present invention may be performed in order to apply color to the pixels 115 defined by the black matrix 120.

In detail, in one cycle P₁ of the printing process, first ink droplets 131 may be discharged from an inkjet head (not illustrated) onto a pixel 115. The first ink droplets 131 may have a predetermined volume or size D₁. In the cycle P₁ of the printing process, the pixel region 115 may be primarily printed with the first ink droplets 131, yielding primarily-printed pixel 115′ (FIG. 1B).

Note that FIG. 1A illustrates a printing process cycle P₁ that involves the deposition of a number N₁ of ink droplets 131 in the pixel 115, where N₁=4. It will be appreciated that the number of ink droplets N₁ may be greater than or less that 4, and that N₁=4 has been used merely for illustrative purposes. That is, any suitable size D may be selected, while the number N of the ink droplets may be adjusted accordingly. Moreover, while a number N₂ of ink droplets illustrated in FIG. 1B is also equal to 4, it will be appreciated that the number N₂ may be greater than or less than 4. Further, the number N of the ink droplets 131 may be varied between printing process cycles, i.e., N₁ may be equal to N₂, or may be greater than or less than N₂.

Referring to FIG. 1B, a second printing process cycle P₂ may be performed to discharge second ink droplets 132 of a predetermined size D₂ through the inkjet head onto the primarily-printed pixel 115′. The size D of the ink droplets may be varied between printing process cycles P. Thus, the size D₂ of the second ink droplets 132 may be smaller than the size D₁ of the first ink droplets 131, as illustrated in FIG. 1B. Alternatively, the size D₂ of the second ink droplets 132 may be greater than the size D₁ of the first ink droplets 131. The primarily-printed pixel region 115′ is secondarily printed with the second ink droplets 132 by the second printing process cycle P₂.

According to the present invention, the inkjet head may be a piezoelectric inkjet head. Where a piezoelectric inkjet head is implemented, it may be capable of easily adjusting the size D of the ink droplets 131, 132, . . . , by changing a waveform of a signal applied to a piezoelectric element of the piezoelectric inkjet head. Thus, modulation of the waveform may be used to modulate deformation of the piezoelectric element which, in turn, modulates the size D of the ejected ink droplets.

Referring to FIG. 1C, a third printing process cycle P₃ may be performed to discharge third ink droplets 133 of a predetermined size D₃ through the inkjet head onto the secondarily-printed pixel region 115″. The size D₃ of the third ink droplets 133 may be smaller than the size D₂ of the second ink droplets 132. The size D₃ of the third ink droplets in the third printing process cycle P₃ may be determined prior to initiation of the printing process, or may be determined during the printing process.

The secondarily-printed pixel region 115″ may be completely printed with the third ink droplets 133 by the third printing process, thereby completing a pixel of a given color. In FIGS. 1A through 1C, a printing process involving three printing process cycles P₁, P₂ and P₃ is illustrated. It will be appreciated, however, that the choice of three printing process cycles P is merely for illustrative purposes, and the printing process may include a greater or lesser number of printing process cycles P. Moreover, the number of printing process cycles P may be varied.

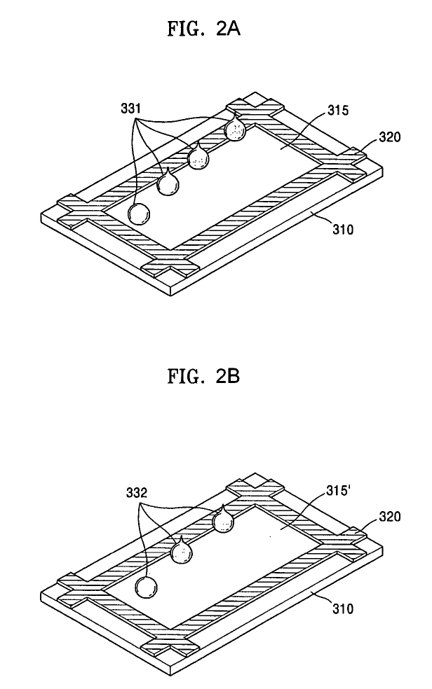

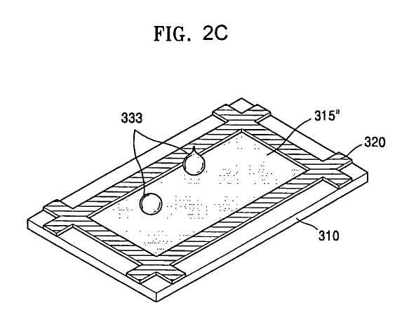

FIGS. 2A through 2C illustrate schematic views of stages in a color filter fabrication method according to a second embodiment of the present invention, in which a number N of ink droplets may be varied between printing process cycles. Referring to FIG. 2A, a black matrix 320 on a substrate 310 may define a plurality of pixels 315. A first printing process cycle may be performed to discharge a number N₁ of first ink droplets 331 onto a pixel 315. The pixel region 315 may be primarily printed with the first ink droplets 331 by the first printing process, yielding primarily-printed pixel 315′ (FIG. 2B).

Note that FIG. 2A illustrates a printing process cycle P₁ that involves the deposition of a number N₁ of ink droplets 331 having size D₁ in the pixel 115, where N₁=4. It will be appreciated that the number N₁ of the ink droplets 331 in printing process cycle P₁ need not be 4, and that any suitable number N may be selected, while the size D of the ink droplets 331 may be adjusted accordingly.

Referring to FIG. 2B, a second printing process cycle P₂ may be performed to discharge a number N₂ of second ink droplets 332 onto the primarily-printed pixel 315′. As illustrated in FIG. 2B, the number N₂ of the second ink droplets 332 is equal to 3. However, it will be appreciated that the number N₂ need not be equal to 3, and, moreover, may be greater than or less than the number N₁ of the first ink droplets 331. The second ink droplets 332 may be of the same size D₁ as the first ink droplets 331. The primarily-printed pixel region 315′ may be secondarily printed with the second ink droplets 332 by the second printing process, yielding secondarily-printed pixel 315″.

Referring to FIG. 2C, a third printing process cycle P₃ may be performed to discharge a number N₃ of third ink droplets 333 through the inkjet head onto the secondarily-printed pixel region 315″. As illustrated in FIG. 2C, the number N₃ of the third ink droplets 333 is equal to 2. However, it will be appreciated that the number N₃ need not be equal to 2, and, moreover, may be greater than or less than the numbers N_{1 and N}₂ of the first and second ink droplets 331 and 332. Further, while FIGS. 2A through 2C illustrate the number N decrementing by 1, the number N may increment or decrement by other amounts and, moreover the increment or decrement need not be linear.

The third ink droplets 333 may be of the same size D₁ as the first and second ink droplets 331, 332. The secondarily-printed pixel region 315″ may be completely printed with the third ink droplets 333 by the third printing process cycle P₃, thereby completing a pixel of a given color. Although FIGS. 2A through 2C illustrate completing the pixel using three printing process cycles P₁, P₂ and P₃, the number of cycles P of the printing processes is not limited to three, and a greater or few number of printing process cycles P may be employed. Further, the number of printing process cycles P may be varied.

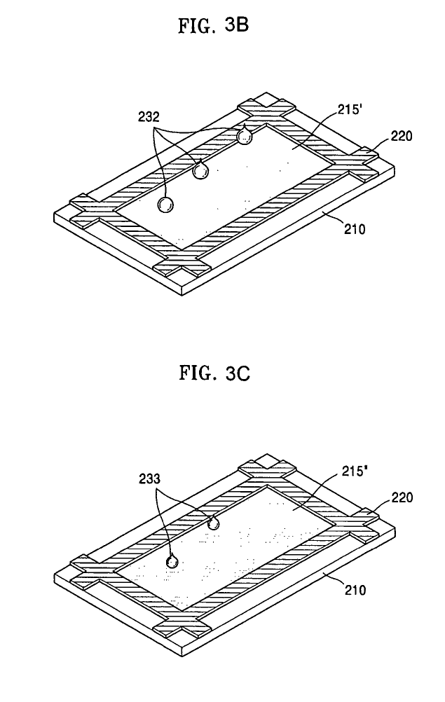

FIGS. 3A through 3C illustrate schematic views of stages in a color filter fabrication method according to a third embodiment of the present invention, wherein both the size D and number N of ink droplets is varied between printing process cycles P. Referring to FIG. 3A, pixels 215 may be partitioned by a black matrix 220 on a substrate 210. A first printing process cycle P₁ may be performed to discharge a number N₁ of first ink droplets 231 having a predetermined size D₁ through an inkjet head (not illustrated) onto each pixel 215, where N₁=4. The pixel 215 may be primarily printed with the first ink droplets 231 by the first printing process cycle P₁. Here again, the choice of N₁=4 is merely for illustrative purposes, and the number N₁ may be varied.

Referring to FIG. 3B, a second printing process cycle P₂ may be performed to discharge a number N₂ of second ink droplets 232 of a predetermined size D₂ onto the primarily-printed pixel 215′. The size D₂ of the second ink droplets 232 may be smaller than the size D₁ of the first ink droplets 231, and the number N₂ of the second ink droplets 232 may be less than the number N₁ of the first ink droplets 231. It will be appreciated that the number N and size D may be varied independently, and that the number N and size D may independently increment or decrement in any suitable manner. Moreover, variations of the number N and size D of the ink droplets may be determined prior to initiation of the printing process, or may be determined during the printing process.

In this embodiment of the present invention, the inkjet head may again be a piezoelectric inkjet head capable of easily adjusting the size of the ink droplets, and the size of the ink droplets may be varied by changing a waveform applied to deform a piezoelectric element. The primarily-printed pixel 215′ may be secondarily printed with the second ink droplets 232 by the second printing process cycle P₂, yielding secondarily-printed pixel 215″ (FIG. 3C).

Referring to FIG. 3C, a third printing process cycle P₃ may be performed to discharge third ink droplets 233 of a predetermined size D₃ through the inkjet head onto the secondarily-printed pixel region 215″. The size D₃ of the third ink droplets 233 may be smaller than the size D₂ of the second ink droplets 232, and the number N₃ of the third ink droplets 233 may be less than the number N₂ of the second ink droplets 232. The secondarily-printed pixel region 215″ may be completely printed with the third ink droplets 233 by the third printing process cycle P₃, thereby completing a pixel of a given color. Again, the number of printing process cycles P need not equal 3, and may be varied.

When the size D and/or number N of the ink droplets are/is adjusted as described above, the deposition of ink can be precisely adjusted to obtain a pixel of a desired color. That is, either the size D or the number N, or both, may be varied to achieve a desired result. The variation in the size D and/or number N between printing process cycles P may be predetermined, or may be determined based on feedback obtained during the printing process. For example, variations in the size D and/or number N of ink droplets may be based on light transmittance of the color filter, which may be determined as the color filter is being fabricated.

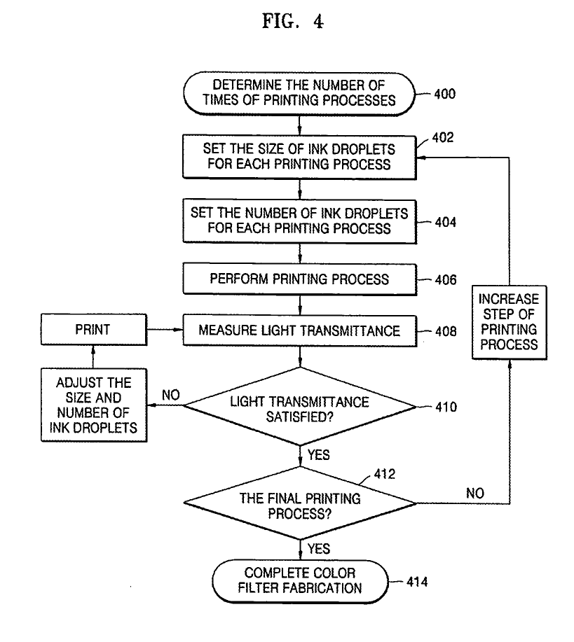

FIG. 4 illustrates a flowchart of a color filter fabrication method according to an embodiment of the present invention. Referring to FIG. 4, the expected number of cycles P of the printing process necessary for fabricating a color filter may be determined in operation 400. The size D of ink droplets for each printing process cycle P may be set in operation 402, and the number N of ink droplets for each printing process cycle P may be set in operation 404. Of course, these operations may be interchanged. The size D and number N of ink droplets for each printing process cycle P may be as described in the aforementioned embodiments. In operation 406, each printing process cycle P may be performed according to the set printing conditions.

After printing, a re-work process for repairing a possible flaw may be performed in operations 408 and 410. In operation 408, the light transmittance of a pixel formed by the printing process may be measured. In operation 410, it may be determined whether the light transmittance measured in operation 408 satisfies a light transmittance requirement. When the light transmittance requirement is not satisfied, the size D and/or number N of ink droplets may be adjusted and a printing task (PRINT) for the flaw repairing process may be repeated until the light transmittance requirement is satisfied. The printing task (PRINT) may be a separate printing process, or may involve a repetition of operations 400 through 406.

After completion of the flaw repairing process, operation 412 may determine whether the performed printing process is the final printing process. That is, operation 412 may determine whether, e.g., additional colors need to be applied to the color filter. When the performed printing process is not the final printing process, a next printing process may be performed or, when the performed printing process is the final printing process, the color filter fabrication may be completed in operation 414.

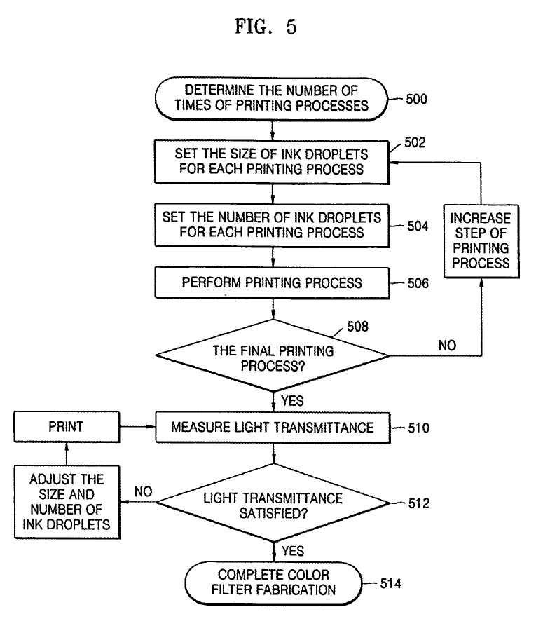

FIG. 5 illustrates a flowchart of a color filter fabrication method according to another embodiment of the present invention. Referring to FIG. 5, the expected number of cycles P of the printing process necessary for fabricating a color filter may be determined in operation 500. The size D of the ink droplets for each printing process cycle P may be set in operation 502, and the number N of ink droplets for each printing process cycle P may be set in operation 504, although these operations may be interchanged. The size D and number N of ink droplets for each printing process cycle P may be as described in the aforementioned embodiments. In operation 506, each printing process cycle P may be performed according to the set printing conditions.

At the end of each printing process cycle P, in operation 508 it may be determined whether the performed printing process is the final printing process and, when the performed printing process is not the final printing process, the next printing process may be performed. Alternatively, when the performed printing process is the final printing process, a process for repairing a possible flaw of each printing process may be performed in operations 510 and 512. In operation 510, the light transmittance of a pixel formed at the completion of the final printing process may be measured. In operation 512, it may be determined whether the measured light transmittance satisfies a light transmittance requirement.

When the light transmittance requirement is not satisfied, the size D and/or number N of ink droplets may be adjusted and a printing task (PRINT) for the flaw repairing process may be repeated until the light transmittance requirement is satisfied. Alternatively, flaw repair may involve a repetition of operations 500 through 506, rather than the printing task (PRINT) operation. When the light transmittance requirement is met by the printing task (PRINT), the color filter fabrication may be completed in operation 514. Thus, according to this embodiment of the present invention, all of the colors may be applied first, and then the flaw-determination process may occur to determine whether re-work of the color filter should be performed.

According to the present invention, the size and/or number of ink droplets used in each printing process cycle may be adjusted. Accordingly, the occurrence of ink overflow may be reduced or prevented. Also, since the deposition of ink can be precisely adjusted, a pixel of a desired color may be accurately obtained. Moreover, re-work of the color filter may be performed by modifying and repeating the printing process, or through a separate re-work process.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of fabricating a color filter, comprising:
depositing an ink color in a pixel of a substrate using at least two printing process cycles, wherein at least one of a size of an ink droplet and a number of ink droplets is varied between the at least two printing process cycles.

2. The method as claimed in claim 1, wherein the size of an ink droplet deposited in the pixel is varied between the at least two printing process cycles.

3. The method as claimed in claim 2, wherein the size of an ink droplet deposited in the pixel decreases between the at least two printing process cycles.

4. The method as claimed in claim 3, wherein the size of an ink droplet deposited in the pixel linearly decreases between the at least two printing process cycles.

5. The method as claimed in claim 2, wherein the number of ink droplets deposited in the pixel is held constant between the at least two printing process cycles.

6. The method as claimed in claim 2, wherein the number of ink droplets deposited in the pixel is varied between the at least two printing process cycles.

7. The method as claimed in claim 6, wherein the size and the number of ink droplets deposited in the pixel decrease between the at least two printing process cycles.

8. The method as claimed in claim 2, wherein the printing process is a piezoelectric printing process and a waveform of a signal applied to a piezoelectric element is varied in order to vary the size of ink droplets deposited in the pixel.

9. The method as claimed in claim 1, wherein the number of ink droplets deposited in the pixel is varied between the at least two printing process cycles.

10. The method as claimed in claim 9, wherein the number of ink droplets deposited in the pixel decreases between the at least two printing process cycles.

11. The method as claimed in claim 10, wherein the number of ink droplets deposited in the pixel linearly decreases between the at least two printing process cycles.

12. The method as claimed in claim 1, further comprising:
determining a number of printing process cycles for depositing the ink color in the pixel;
setting a size of ink droplets for each of the printing process cycles;
setting a number of ink droplets for each of the printing process cycles;
performing the number of printing process cycles; and
completing a final printing process.

13. The method as claimed in claim 12, further comprising performing a flaw repairing process after performing each printing process cycle and before completing the final printing process.

14. The method as claimed in claim 13, wherein the flaw repairing process comprises:
adjusting at least one of the size of an ink droplet and the number of ink droplets; and
performing a printing task for the flaw repairing process until a pixel light transmittance requirement is satisfied.

15. The method as claimed in claim 12, further comprising performing a flaw repairing process after completing the final printing process.

16. The method as claimed in claim 15, wherein the flaw repairing process comprises:
adjusting at least one of the size of an ink droplet and the number of ink droplets; and
performing a printing task for the flaw repairing process until a pixel light transmittance requirement is satisfied.

17. The method as claimed in claim 1, wherein depositing an ink color in a pixel of a substrate using at least two printing process cycles includes:
setting initial values for a first of the at least two printing process cycles, wherein setting the initial values includes setting an initial size of ink droplets, and setting an initial number of ink droplets;
performing the first printing process cycle to deposit the ink color in the pixel;
determining a pixel light transmittance after performing the first printing process cycle;
varying at least one of the size of ink droplets and the number of ink droplets based on the pixel light transmittance; and subsequently
performing a second of the at least two printing process cycles to deposit the ink color in the pixel.

18. The method as claimed in claim 1, wherein the pixel is defined by a black matrix formed on the substrate.
